(19) United States
(12) Patent Application Publication
(10) Pub. No.: US 2014/0165394 A1
(43) Pub. Date: Jun. 19, 2014

(54) METHOD FOR ELECTRICALLY CONDUCTIVELY CONNECTING A STRANDED CONDUCTOR TO A CONTACT ELEMENT

(71) Applicants: Bayerische Motoren Werke Aktiengesellschaft, Muenchen (DE); NEXANS, Paris (FR)

(72) Inventors: Helmut Steinberg, Stoernstein (DE); Udo Mayer, Weiden (DE); Johannes Denteler, Vaterstetten (DE); Sunhilde Fleischer, Prittriching (DE)

(21) Appl. No.: 14/102,863

(22) Filed: Dec. 11, 2013

(30) Foreign Application Priority Data
Dec. 18, 2012 (EP) 12 306 605.2

(51) Int. Cl. H01R 43/048; H01R 43/02

(52) U.S. Cl. CPC H01R 43/048; H01R 43/0207
USPC 29/860; 29/863

(57) ABSTRACT

A method of electrically conductively connecting a stranded conductor, which has a plurality of wires containing aluminum, to an electrical contact element, by means of which any oxide layers which may surround the wires are destroyed, and by means of which a component consisting of metal is fastened to the conductor by crimping. The stranded conductor is electrically conductively connected at its end to the contact point provided on the contact element while destroying the oxide layers, and the structural component integrally connected to the contact element and acting as a mechanical holding element is crimped around the stranded conductor at a distance from the contact point.

### RELATED APPLICATION

This application claims the benefit of priority from European Patent Application No. 12 306 605.2, filed on Dec. 18, 2012, the entirety of which is incorporated by reference,

### BACKGROUND

1. Field of the Invention

The invention relates to a method of electrically conductively connecting a stranded conductor, which has a plurality of wires containing aluminum, with an electrical contact element by means of which the wires destroy the oxide layers which may possibly surround the wires and by means of which a structural component consisting of metal is attached by crimping to the conductor.

Such a method is disclosed in EP 2001 085 B1.

2. Description of Related Art

Conductors containing aluminum are used more and more as a replacement for copper conductors, for example, in the automobile and airplane industries. The conductors used in these industries which contain aluminum consist either of aluminum or of an aluminum alloy. A significant advantage, of such electrical conductors is their low weight as compared to copper. However, the lower electrical conductivity of the aluminum as compared to copper is of subordinate significance for most of today's applications. A disadvantage of these conductors is the fact that aluminum reacts with oxygen which causes electrically insulating oxide layers to be formed which surround the wires of an appropriate conductor.

U.S. Pat. No. 3,717,842 A describes a method in which a metal contact element is crimped onto a stranded conductor consisting of aluminum wires. The contact element has at its one end components which are crimped around the stranded conductor. At its other end, the contact element is bent in such a way that it can be plugged into another electrical contact. Additionally, ultrasound is admitted to the crimped connection which improves the electrical connection between conductor and contact element, and oxide layers which may surround the aluminum wires are broken up.

The above mentioned EP 2001 085 B1 discloses a method for manufacturing an electrically conductive connection between a stranded conductor containing aluminum and a contact part of an electric or electronic device. At the end of the conductor whose insulation has been removed, a contact element is electrically conductively fastened by crimping. Subsequently, the contact element is connected to the contact part of the device. When crimping the contact element, the oxide layers of the stranded conductor are broken through, so that an electrically conductive connection is provided between contact element and conductor. This connection has been found useful in practice. However, the connection can also be impaired in unfavorable cases when subjected to significant vibrations as they occur, for example, during operation of a motor vehicle.

### OBJECTS AND SUMMARY

The invention is based on the object of further developing the above described method in such a way that the contact point between the conductor and the contact element is effectively protected against vibrations.

In accordance with the invention, the object is met in
that the stranded conductor is electrically conductively connected at its end to a contact point located on the contact element as the oxide layers of the wires are destroyed, and
that the structural component acting as a mechanical holding part is integrally connected to the contact element at a distance from the contact point around the stranded conductor.

In this method, the electrically conductive connection between the contact element and the conductor as well as the mechanical unloading of the contact point are separated from each other, however, with the use of a single piece component. The electrically conductive connection is, for example, manufactured by ultrasound welding such that possibly present oxide layers are broken up, so that the electrically conductive material of the conductor is connected directly to the contact element. Oxide layers, which possibly form after the completion of the contact point, remain without influence. The mechanical unloading of the contact point is achieved by the crimped holding part which surrounds the conductor in the immediate vicinity of the contact point sufficiently strongly, so that neither bending loads nor tensional loads, and especially also significant vibrations, cannot have any effect on the contact point in the long run. It is significant in this connection that the holding part merely serves for the mechanical stabilization of the conductor, while the electrical connection is effected. between the conductor and the contact element.

### BRIEF DESCRIPTION OF THE DRAWINGS

The method according to the invention will be explained in the following with the aid of the drawings.

In the drawing:

FIG. 1 is a schematic illustration of a contact element which can be used in the method according to the invention.

FIG. 2 shows the end of an electrical conductor.

FIGS. 3 and 4 show two different views of a contact point according to FIG. 1.

### DETAILED DESCRIPTION

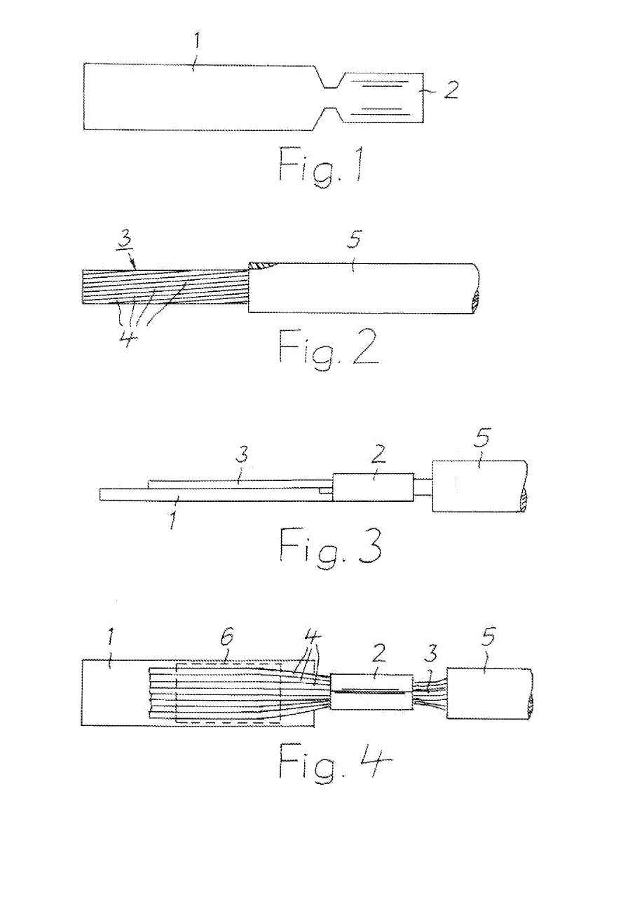

The schematically illustrated contact element 1 in FIG. 1 is, for example, composed of copper. However, it can also be composed of a metal with good electrical conductivity. The contact element 1 is to be used, for example, in motor vehicles. During assembly, the contact element 1 is connected to electrical contact units in the electrical contact parts which may be, for example, a starter, an electric motor, or other devices which conduct electrical current. The connection may be effected by, for example, plugging, screwing or welding. The contact element 1, in accordance with FIG. 1, is a flat structural component having approximately a rectangular cross section. However, it may also have other geometric shapes. A holding part 2 suitable for crimping is connected integrally to the contact element 1.

An electrical conductor to be connected electrically as well as mechanically to the contact element 1 is, in accordance with FIG. 2, a stranded conductor 3, in the following called “conductor 3,” which consists of a plurality of wires 4 which are formed into a unit. The wires 4 may be, for example, stranded together. In the present case, the wires 4 consist of aluminum or an aluminum alloy. The conductor 3, which has good bending capability as a result of the construction as a current conductor, is surrounded by an insulation 5 which is removed from the end 3 for carrying out the method according to the invention.

For electrically conductively connecting the conductor 3 to the contact element 1, an arrangement is used which ensures that oxide layers, which surround the individual wires 4 of the conductor 3, are broken up. This makes it possible that the electrically conductive material of the conductor 3 or the wires 4 are electrically conductively connected to the contact element 1 after the method has been carried out. Such an arrangement is preferably an ultrasonic welding unit. However, in accordance with a preferred embodiment, the arrangement could also be, for example, an electric welding unit whose voltage is high enough for destroying the oxide layers, or which are coupled to a mechanical device by means of which the aforementioned oxide layers are broken up.

The method according to the invention is carried out, for example, as follows:

The conductor 3, prepared in accordance with FIG. 2, is with its end placed on the contact element 1. The respective position can be mechanically stabilized by the holding part 2 which is crimped around the conductor 3. Subsequently, the conductor 3 or the wires 4 can be placed on the contact element 1 and are electrically conductively welded to the contact element 1 by means of an ultrasonic welding unit. In the illustrated geometric shape of the contact element 1, the contact element 1 results in a flat structural component as an approximately rectangular contact point 6, shown in broken lines in FIG. 4. The surface of the sonotrode of the ultrasonic welding unit facing the conductor 3 is advantageously always adapted in its geometric shape when it completely covers the conductor 3. This is particularly true when the contact element 1 is not constructed as a flat structural component according to FIGS. 1 to 3, but has a different geometric shape.

In accordance with another embodiment of the method, the conductor 3—as described above—can initially he connected without actuating the holding part 2 with the contact element 1. After finishing the electrically conductive connection between conductor 3 and contact element 1, the holding part 2 is crimped around the conductor 3 for mechanical support of the contact point 6.

1. Method of electrically conductively connecting a stranded conductor, where the conductor contains a plurality of wires containing aluminum, to an electrical contact element by means of which the upper layers of the oxide layers which may surround the wires are destroyed, and by means of which a structural component composed of metal is fastened to the conductor by crimping, said method comprising the steps of:
Electrically onductively connecting the stranded conductor at its end to the contact point which is present on the contact element destroying the oxide layers of the wires; and
Integrally connecting the structural component to the contact element and acting as a mechanical holding par is crimped around the stranded conductor at a distance from the contact point.

2. Method according to claim 1, wherein initially the stranded conductor and the contact element are electrically conductively connected to each other at the contact point, and that subsequently, the holding part is crimped around the stranded conductor.

3. Method according to claim 1, wherein initially the holding part is crimped around the stranded conductor, and the stranded conductor is subsequently electrically conductively connected to the contact point at the contact element.

4. Method according to claims 1, wherein the stranded conductor and the contact element are electrically conductively connected to each other by means of an ultrasonic welding unit.
